(19) United States
(12) Patent Application Publication
(10) Pub. No.: US 2011/0020775 A1
(43) Pub. Date: Jan. 27, 2011

(54) Sentence wheel

(76) Inventor: David A. Cecil, Millers, MD (US)

Correspondence Address: JOHN E. SIMMS JR., 6803 YORK ROAD, SUITE 202, BALTIMORE, MD, 21212, US

(21) Appl. No.: 12/802,805

(22) Filed: Jun. 15, 2010

Related U.S. Application Data
(60) Provisional application No. 61/271,867, filed on Jul. 27, 2009.

(51) Int. Cl. G09B 1/00

(52) U.S. Cl. 434/172

(57) ABSTRACT

A sentence wheel comprising four circular disks, each having a different diameter. The disks are ordered sequentially, by diameter, superimposed concentrically, with an outermost portion of each disk in view. The disks are joined, by a rivet, in independently rotatable relation, about a common axis. The disk of smallest and largest diameter being a first and last disk, respectively, and the two disks of intermediate diameter being medial disks. A plurality of word sets are imprinted outwardly along a radius, in circumferentially spaced relation on the outermost portion, of each of the disks. The disks may be rotated to position one of the word sets on each disk along a common radius of the sentence wheel for forming a sentence. Pronouns or proper nouns are imprinted on the first disk, nouns are imprinted on the last disk, and auxiliary verbs, modal auxiliaries, and verbs are imprinted on the medial disks.

### CROSS REFERENCE TO OTHER APPLICATIONS

Applicant claims the benefit of Provisional Application Ser. No. 61/271,867, filed 27 Jul. 2009, by the within named inventor.

### BACKGROUND

In the field of language instruction, students must be taught to select and order words to express thoughts in a sentence with proper syntax. Once a student has accomplished the task of building a basic vocabulary, the assembly of sentences, in proper syntax, may be best taught by presenting examples of properly formed sentences. Many simple sentences may be formed by selecting and ordering basic elements to construct a subject and a predicate. A sentence wheel, consisting of a plurality of circular disks, of different diameter, which are concentrically joined for independent rotation about a common axis is a valuable tool. Each disk has an outermost portion exposed to view and imprinted with a plurality of circumferentially spaced words, for forming sentence elements. Words are typically imprinted radially outward, on the exposed portion of each disk. The disks may be rotated to select a word from each disk, by forming a line of words along a radius of the wheel. The sentence wheel is portable and self contained with no separate parts, which may be easily lost or misplaced. Selected words may be conveniently interchanged by rotating one or more of the disks.

An instructor may use a sentence wheel to demonstrate the formation of sentences having correct as well as incorrect syntax by rotating the disks to select a group of words positioned along a radius of the wheel, as an exemplary sentence. A student may use the sentence wheel to practice selecting a group of words to form a proper sentence. The structure of a sentence wheel formed of a plurality of circular disks allows a relatively large number of choices on each disk; however, the order of the words is fixed in that the first word of the sentence will be the word selected on the disk of smallest diameter, the second word in the sentence will be the word selected on the disk of next larger diameter, and so progressing, with the last word in the sentence being the word selected on the disk of largest diameter. In forming simple sentences, it is advantageous to select words of particular parts of speech for the first last and intermediate words forming a sentence. By way of example, a great number of simple declarative sentences may be formed by selecting a pronoun or proper noun as the first word, a noun for the last word, and a verb, an auxiliary verb, or a modal auxiliary, as one or more medial words. A student manipulating a sentence wheel may have difficulty recognizing words of appropriate parts of speech, for each sentence element, among the words on the disks. In addition, a student having a limited vocabulary may have difficulty understanding the meaning of many words imprinted on the disks.

There is a need for a sentence wheel having a disk of smallest diameter having words selected from the group of words comprising pronouns and proper nouns, a disk of largest diameter having words selected from the group of words comprising nouns, and one or more disks of intermediate diameter having words selected from the group of words comprising verbs, auxiliary verbs, and modal auxiliaries, so as to automatically preselect the part of speech for words available for selection on each disk. There is a need for a sentence wheel having fill-in spaces included on one or more of the disks for imprinting with specific words familiar to an individual student.

### SUMMARY OF THE INVENTION

The present invention is a sentence wheel for language instruction comprising at least three circular disks, each having a different diameter. The disks are ordered sequentially, by diameter, superimposed concentrically, and joined by connecting means, for independent rotation about a common axis, so as to expose an outermost portion of each of the disks. The outermost portion of the disks is imprinted with a plurality of word sets. A word set may comprise a single word, an article or preposition together with another word, an adjective with a noun, or a plurality of words ordered to form a sentence element. The word sets are spaced apart circumferentially and set outwardly along a radius of the disks. One or more of the disks may be rotated to select a word set on each disk by positioning the word set along a common radius, of the sentence wheel to present the selected word sets on the disks as a phrase or sentence.

The disks may include a disk of smallest diameter, a disk of largest diameter, and one or more medial disks of intermediate diameter. Word sets imprinted on the disk of smallest diameter may be selected from the group including pronouns and proper nouns. Word sets imprinted on the disk of largest diameter may be selected from the group including nouns. Word sets imprinted on the medial disk or disks may be selected from the group including verbs, auxiliary verbs, and modal auxiliaries. One or more of the disks may include fill-in spaces for receiving word sets selected and written by individual users of the sentence wheel.

It is an object of the present invention to provide a sentence wheel having a disk of smallest diameter populated by word sets selected from among the group including pronouns and proper nouns, a disk of largest diameter populated with word sets selected from among the group including nouns, and one or more medial disks populated with word sets selected from among the group including verbs, auxiliary verbs, and modal auxiliaries for preselecting the parts of speech for word sets selected on the disks to facilitate the formation of proper sentences. It is a further object of the present invention to provide a sentence wheel having fill-in spaces included on one or more of the disks to facilitate populating the sentence wheel with words familiar to an individual student.

### BRIEF DESCRIPTION OF THE DRAWINGS

The invention will be further understood, by way of example, with reference to the accompanying drawings, in which:

FIG. 1 is a top plan view of the sentence wheel representing an embodiment of the present invention.

FIG. 2 is an elevation view of the sentence wheel showing the rivet in phantom lines.

FIG. 3 is an exploded perspective view of a sentence wheel.

FIG. 4 is a top plan view of a sentence wheel showing a human hand manipulating a writing implement to add a personal pronoun on a blank line provided on a first disk.

### DETAILED DESCRIPTION OF THE PREFERRED EMBODIMENT

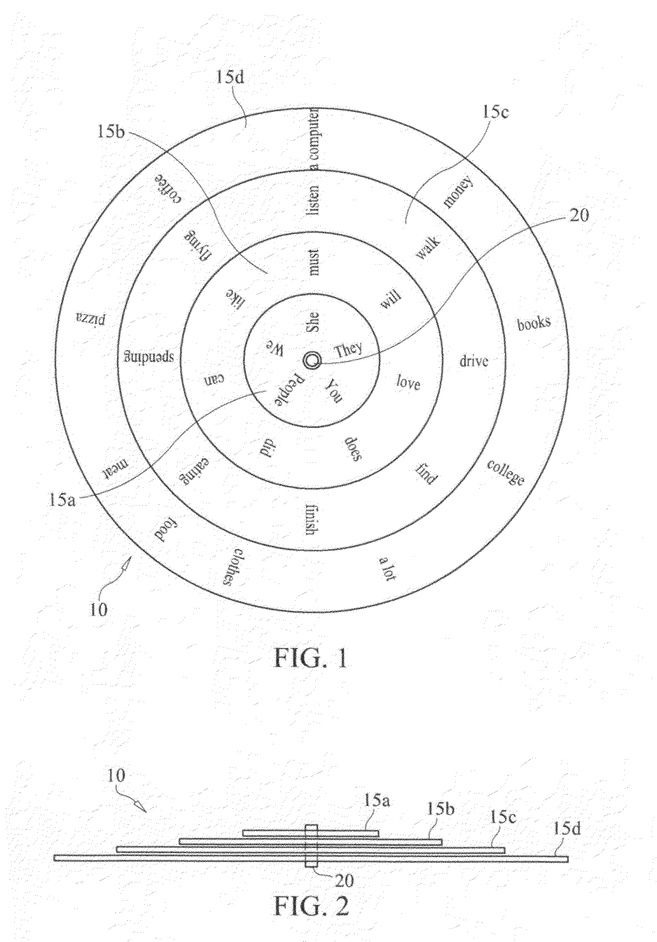

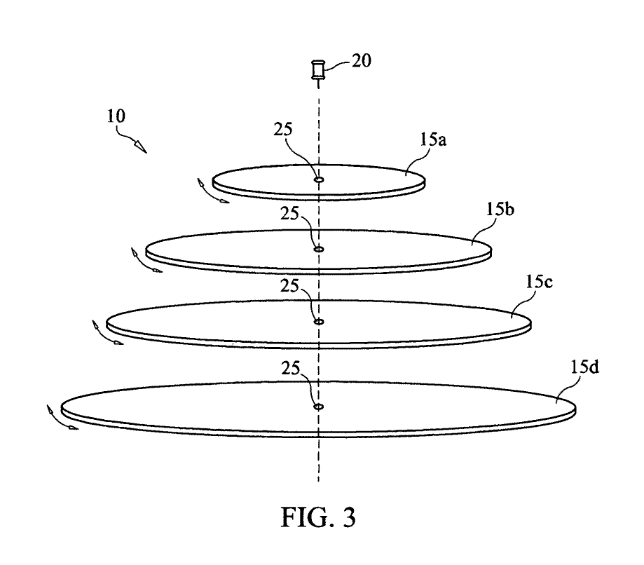

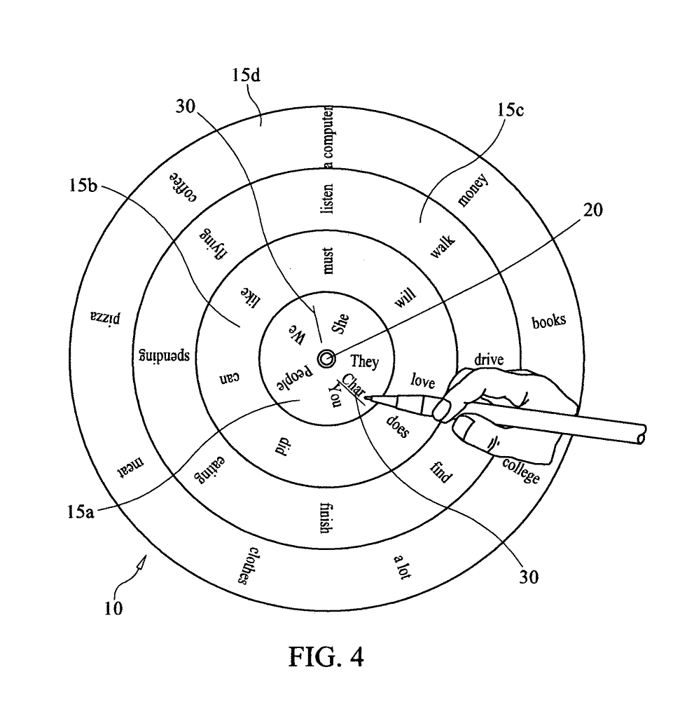

The present invention is directed to a sentence wheel for language instruction. The sentence wheel is formed of at least three circular disks, each having a different diameter. The disks are ordered sequentially, by diameter, superimposed concentrically, and joined, by connecting means, for independent rotation about a common axis. The disk of smallest diameter is designated as a first disk and the disk of largest diameter is designated as a last disk. The one or more disks of intermediate diameter, disposed between the first and last disks, are medial disks. The exemplary sentence wheel 10, representing an embodiment of the present invention, is shown in FIGS. 1-4 and is formed of four circular disks 15a, 15b, 15c, and 15d. The disks 15a-d are ordered sequentially, by diameter, the disk of smallest diameter being designated as the first disk 15a, the next two disks are medial disks being designated as the second disk 15b and the third disk 15c, and the last disk of largest diameter being designated as the fourth disk 15d, as shown in FIG. 1. The disks 15a-d are superimposed concentrically, and joined, by connecting means, for independent rotation about a common axis, as shown in FIG. 2 and as indicated in FIG. 3, by double headed arrows. The disks 15a-d are preferably formed of stiff, flexible, and resilient material, such as card stock, card board, or plastic. Connecting means preferably comprises a rivet 20, best seen in FIG. 3, disposed in a holes 25 provided at the common center point of each of the disks 15a, 15b, 15c, and 15d, for retaining the disks 15a-d in independently rotatable relation about the rivet 20, with an outermost portion of each of the disks 15a-d exposed in view, as shown in FIG. 1.

Word sets are preferably selected and imprinted, radially outward, circumferentially spaced, and in the outermost portion, on each of the disks 15a-d, such that word sets on all of the disks 15 a-d remain continuously in view, as shown in FIG. 1. Word sets may comprise a single word, an article or preposition together with another word, an adjective with a noun, or a plurality of words ordered to form a sentence element. For the exemplary sentence wheel 10 shown in FIGS. 1-3, having four disks 15a-d, word sets are preferably selected from four separate groups, as shown in Table I, below. Exemplary first words sets, consisting of nouns and pronouns, appear in column A and are preferably imprinted on the first disk 15a. Exemplary second word sets, consisting of auxiliary verbs and modal auxiliaries, appear in column B and are preferably imprinted on the second disk 15b. Exemplary third word sets, consisting of verbs, appear in column C and are preferably imprinted on the third disk 15c. Exemplary fourth word sets, consisting of nouns, appear in column D and are preferably imprinted on the fourth disk 15d. It will be appreciated that the word sets listed in Table I are exemplary and numerous other word sets may be imprinted on a sentence wheel within the scope of the present invention.

TABLE I

| A | B | | |
|---|---|---|---|
| pronouns, proper | auxiliary verbs, | C | D |
| nouns | modal auxiliaries | verbs | nouns |
| I | will | go | vegetables |
| You | will be | go to | meat |
| People | like | listening | chicken |
| He | like to | listening | potatoes |
| She | likes to | drink | tomatoes |
| Friends | does | save | french fries |
| We | doesn't | saving | pizza |
| It | did | drive | tea |
| They | didn't | driving | coffee |
| | can | walk | ice cream |
| | can't | walking | an iPod ® |
| | love | bake | a computer |
| | love to | baking | money |
| | loves to | wear | to work |
| | started | wearing | to school |
| | were | attend | books |
| | won't | attending | TV |
| | don't | sing | songs |
| | quit | singing | high school |
| | finished | use | movies |
| | was | using | college |
| | might | read | yesterday |
| | loves | reading | today |
| | do | watch | tomorrow |
| | must | watching | a lot |
| | is | start | socks |
| | isn't | starting | clothes |
| | are | find | shoes |
| | aren't | finding | furniture |
| | would | finish | |
| | wouldn't | finishing | |
| | should | laugh | |
| | shouldn't | laughing | |
| | could | spend | |
| | couldn't | spending | |
| | | eat | |
| | | eating | |
| | | like | |
| | | buy | |
| | | buying | |
| | | fly | |

The sentence wheel 10 of the present invention, is particularly well suited for instruction of adults learning a language additional to their native language. The sentence wheel 10 may be adapted to this purpose by selecting third word sets (see Table I, column C) from verbs in the following tenses: future simple, present simple, past simple, present continuous, and past continuous. It is also advantageous to facilitate recognition of the word sets by students. In addition to selecting word sets from words generally expected to be included in a basic vocabulary of a new student of the language being taught, the present invention includes additional enhancements. First, the first disk 15a may include one or more fill-in spaces, indicated by blank lines 30 on which a student may write a familiar proper noun or other noun, as shown in FIG. 4. The student will readily recognize the personally written names as he or she manipulates the sentence wheel 10. Fill-in spaces may also be used on any of the disks 15a-d as well. Second, the fourth word sets (see Table I, column D) may be selected from words related as to subject matter category and grouped together, for example, the word “food” and specific foods, such as “pizza”, “tacos” and “sandwich” or the word “furniture” and specific types of furniture, such as “table”, “chair” and “bed”, to help the student recognize the fourth word sets. It will be understood that first, second, third, and fourth word sets may be selected from specific categories of words. Readily recognizable words commonly used in business such as landscaping or drywall installation are preferred.

In use, any of the disks 15 a-d may be independently rotated to position a selected first word set, a selected second word set, a selected third word set, and a selected fourth word set along a common radius of the sentence wheel 10, as shown in FIG. 1, to form a sentence, which may be perceived by reading the selected word sets, in sequence, outwardly along the radius. Any of the disks 15 a-d may be independently rotated to interchange one or more word sets, thereby altering the sentence. An instructor may manipulate the sentence wheel 10 to quickly and easily interchange word sets forming sentence elements, to demonstrate correct as well as incorrect syntax. A student may practice sentence formation by manipulating the sentence wheel 10 to interchange word sets forming sentence elements. The reverse side of the first disk 15a may display printed indicia such as instructions for use. Having fully described the present invention, it will be appreciated that minor variations may be introduced without departing from the scope of the invention as disclosed and claimed herein.

The applicant claims:

1. A sentence wheel for language instruction, comprising:
at least three circular disks, each having a different diameter;
said disks being ordered sequentially by diameter, concentrically superimposed, and joined by connecting means;
said connecting means being configured to provide independent rotation, of said disks, about a common axis, and to expose an outermost portion of each of said disks;
said disks of smallest and largest diameter being first and last disks respectively;
said disks of intermediate diameter being medial disks;
said outermost portion of each of said disks being imprinted with a plurality of word sets;
said word sets being spaced apart circumferentially and set outwardly along a radius of said disks;
said word sets on said first disk being pronouns, nouns, or proper nouns;
said word sets on said last disk being nouns;
said word sets on said medial disks being auxiliary verbs, modal auxiliaries, or verbs;
whereby one or more of said disks may be rotated to select a word set on each disk, by positioning said word set on a common radius of said sentence wheel for presenting said selected word sets as a phrase or sentence.

2. The sentence wheel of claim 1, wherein said at least three circular disks comprises four circular disks;
said four circular disks being said first disk of smallest diameter, said last disk of largest diameter, a second disk and third disk being said medial disks and having intermediate diameters;
said word sets on said third disk being in a tense selected from the group consisting of: future simple, present simple, present continuous, and past continuous.

3. The sentence wheel of claim 2 wherein said word sets on said last disk are selected so as to be related as to subject matter category.

4. A sentence wheel for language instruction, comprising:
at least three circular disks, each having a different diameter;
said disks being ordered sequentially by diameter and concentrically joined by connecting means;
said connecting means being configured to provide independent rotation, of said disks, about a common axis, and to expose an outermost portion of each of said disks;
said outermost portion of each of said disks being imprinted with a plurality of word sets and fill-in spaces;
said word sets and fill-in spaces being spaced apart circumferentially and set outwardly along a radius of said disks;
said word sets on said first disk being pronouns, nouns, or proper nouns;
said word sets on said last disk being nouns;
said word sets on said medial disks being auxiliary verbs, modal auxiliaries, or verbs;
whereby one or more of said disks may be rotated to select a word set or fill-in space on each disk, by positioning said word set or fill-in space on a common radius of said wheel for presenting said selected words or fill-in spaces as a phrase or sentence.

5. The sentence wheel of claim 4, wherein said at least three circular disks comprises four circular disks;
said four circular disks being said first disk of smallest diameter, said last disk of largest diameter, a second disk and third disk being said medial disks and having intermediate diameters;
said word sets on said third disk being in a tense selected from the group consisting of: future simple, present simple, present continuous, and past continuous.

6. The sentence wheel of claim 4 wherein said word sets on said last disk are selected so as to be related as to subject matter category.

7. A process for instruction in sentence formation comprising the steps of:
providing a sentence wheel including:
at least three circular disks, each having a different diameter;
said disks being ordered sequentially by diameter and concentrically joined by connecting means;
said connecting means being configured to provide independent rotation, of said disks, about a common axis, and to expose an outermost portion of each of said disks;
said outermost portion of each of said disks being imprinted with a plurality of word sets and fill-in spaces;
said word sets and fill-in spaces being spaced apart circumferentially and set outwardly along a radius of said disks;
said word sets on said first disk being pronouns, nouns, or proper nouns;
said word sets on said last disk being nouns;
said word sets on said medial disks being auxiliary verbs, modal auxiliaries, or verbs;
writing one or more words in said fill-in spaces;
manipulating said disks to align selected word sets and written words along a common axis of said sentence wheel for presenting said selected word sets and written words as a sentence.

8. The process of claim 7 wherein:
said at least three circular disks comprises four circular disks;
said four circular disks being said first disk of smallest diameter, said last disk of largest diameter, a second disk and third disk being said medial disks and having intermediate diameters;
said word sets on said third disk being in a tense selected from the group consisting of: future simple, present simple, present continuous, and past continuous.

9. The process of claim 7 wherein:
said word sets on said last disk are selected so as to be related as to subject matter category.
